(19) United States
(12) Patent Application Publication
(10) Pub. No.: US 2002/0144099 A1
(43) Pub. Date: Oct. 3, 2002

(54) Hardware architecture for fast servicing of processor interrupts

(76) Inventors: Manuel R. Muro JR., Chandler, AZ (US); Timothy J. Phoenix, Gilbert, AZ (US)

Correspondence Address: RONALD L. CHICHESTER, BAKER BOTTS L.L.P., ONE SHELL PLAZA, 901 LOUISIANA STREET, HOUSTON, TX, 77002-4995, US

(21) Appl. No.: 09/769,677

(22) Filed: Jan. 25, 2001

(51) Int. Cl. G06F 9/30

(52) U.S. Cl. 712/228; 712/244

(57) ABSTRACT

An improved computer processor architecture in the form of an apparatus with a mirrored stack and method of using the same are provided that enable a processor to recover from an interrupt service routine in one or zero processor instruction cycles. The architecture also removes from software the burden of preserving and maintaining the processor registers upon an interrupt event, thereby improving coding efficiency and the utilization of processor time. The architecture makes it possible to extend faster servicing of interrupts for different levels of interrupt priorities and not just a specific interrupt path. Finally, the architecture provides a mechanism for speeding up CALL and RETURN instruction execution times. In an alternate embodiment, the mirrored stack apparatus is provided with interrupt control logic that has a port to the Program Counter control logic in order to drive directly an interrupt vector address.

### CROSS REFERENCE TO RELATED PATENT APPLICATION

This application is related to pending U.S. patent application Ser. No. [MTI-1540] filed on, entitled “MIRRORING PROCESSOR STACK” in the name of Manuel R. Muro, Jr., that is assigned to the same assignee as the present application and is incorporated herein by reference for all purposes.

### BACKGROUND OF THE INVENTION

1. Field of the Invention

The present application is related to microprocessors. More specifically, the present application is related to a microprocessor architecture that facilitates the rapid servicing of processor interrupts and the recovery therefrom.

2. Description of the Related Technology

Digital electronics has become an integral part of all types of products purchased by the consumer, business and industry. These products may comprise alarm systems, remote monitoring and control systems, portable electronic devices such as computers, cellular telephones, personal digital assistants (PDA), portable global positioning satellite (GPS) terminals, and the like.

The use of microprocessors has proliferated in recent years partly due to the ability of designers of such to produce flexible, easy-to-use systems. Moreover, microprocessors are usable for both traditional data processing environments and as replacements for random logic systems. With the proliferation of devices, it has become desirable to provide more flexible and easy to use microprocessors to aid system designers in incorporating the devices into larger systems. High data rates are also desirable in some applications, and increased throughput, with easy-to-use devices is a continuing design goal. One way to achieve high data rates is to operate on larger pieces of data in parallel.

Digital computer memory contains cells, which may be referred to by addresses. The address of a memory cell is sometimes referred to as a pointer, since it may be thought of as pointing to the memory cell to which it refers. Pointers may occur at the level of machine language both as direct addresses and as indirect addresses. Pointers may also be encountered in mid-level languages such as C and high level languages such as PASCAL. In general, pointers may be used to connect individual memory cells and also to point from one composite data structure to another. Pointers are essential in any composite data structure for linking components of the data structure.

Most digital processors employ one or more stacks. A stack is a linear list of memory locations for which all insertions and deletions, and usually all access, are made at one end of the list. The properties of a simple stack may be illustrated by a railroad switching network having a track into which railroad cars may be inserted and removed from only one end. At any given time, only the most recently entered railroad car may be removed from the track. Railroad cars are said to enter and leave the track in a last-in-first-out (LIFO) order. Alternatively, a stack may be defined as a linear list whose elements may be created and deleted only in a last-in-first-out order. Stacks arise in computational programming dealing with structures whose components are nested. See, e.g., Anthony Ralston and Edward D. Reilly, “ENCYCLOPEDIA OF COMPUTER SCIENCE, Third Edition (1993, Van Nostrand Reinhold) ISBN 0-442-27679-6.

Almost all digital processors (microprocessors) have the capability of responding to an interrupt request. There are three basic kinds of interrupts: Hardware interrupts, software interrupts and processor exceptions. Besides the three kinds, interrupts can also be characterized in two types. The first type is where the interrupt can be enabled or disabled under software control and are called maskable interrupts. Interrupts that cannot be masked are termed a non-maskable interrupt and this type of interrupt can never be masked by a programmer.

An interrupt request indicates to the processor that an external event has occurred that requires immediate servicing. In many applications it is desirable to provide an interrupt servicing routine which occurs much faster than the previously mentioned two types of interrupts.

U.S. Pat. No. 4,386,402, by Toy, discloses a processor interrupt stack memory and cache memory that share a common data memory. In Toy, the interrupt stack memory and the cache memory are accessed using virtual addresses. In Toy, a separate address translation buffer is used for both the interrupt stack memory and the cache memory in order to perform the virtual address to real address translations that are required to access the common data memory. The cache address translation buffer and a cache controller provide the addressing to access the cache data words in the common memory. In Toy, the interrupt stack address translation buffer alone provides the addressing necessary to access the interrupt stack data words in the common memory.

U.S. Pat. No. 4,296,470, by Fairchild, et al., discloses a mechanism that employs a set of storage address link registers for nested branching both during the execution of a normal program and during the execution of an interrupt service program that breaks into the normal program and takes control of the processor for a short interval of time. Fairchild also discloses another mechanism for saving the normal program values in the link registers at the commencement of the interrupt service program. Fairchild further discloses a mechanism for monitoring the usage of the link registers by the interrupt program thus enabling the normal program values to be restored in the link registers only after all interrupt program values have been removed from the link register.

U.S. Pat. No. 4,250,546, by Boney, et al., disclosed a method of responding to a fast interrupt in a digital dataprocessor capable of handling more than one type of interrupt request. According to Boney, the method of handling the fast interrupt request comprises receiving the fast interrupt request and in response thereto setting a memory or storage means to a predetermined state. The subset machine state is saved by stacking the program counter and also stacking the condition code register which contains the status of the machine. Once the interrupt has been serviced, a return from interrupt instruction (RTI) causes the condition code register to be unstacked and then the storage means is tested to verify that it has been set to the predetermined state. If the storage means is in the predetermined state then this indicates to the processor that only the program counter has been stacked and accordingly the program counter is then unstacked and the digital data processor continues its normal programming. According to Boney, “[b]y only saving contents from a few of the many control registers that the data processor has, the fast interrupt can be serviced in a shortened response time.”

Similarly, others (e.g. Motorola, Inc.) have reduced the latency associated with servicing interrupts by limiting the number of processor registers that get placed on the stack to restore the state of the processor prior to the interrupt event. For example, in the ARM RISC processor, a few of its working registers have extra register banks with which to switch. However, the interrupt depth is limited.

Another example of the prior art is the TMS9900 manufactured by Texas Instruments. The TMS9900 was a 16-bit processor that placed its working registers into external RAM. When that processor had an interrupt, it would simply adjust the working register address pointer to a new location in RAM rather than placing the register values on a stack (as with other prior art devices).

While the TMS9900 had some excellent features, one of its drawbacks was that it could not reduce the time needed to get the Program Counter (PC), thus precluding a reduction of the interrupt latency to one or zero CPU cycles.

Unfortunately, saving a few of the many control registers does not eliminate all or almost all of the time needed to reconfigure the system after the end of an interrupt service routine. Moreover, simply switching from one set of registers to another also does not reduce the time needed to reconfigure after an interrupt. Therefore, what is needed is a system, method and apparatus for recovering from an interrupt service routine in one or fewer processor cycles.

### SUMMARY OF THE INVENTION

The present invention solves the problems inherent in the prior art by providing an apparatus, system and method of servicing interrupts in one clock cycle or less. The present invention provides one or more M-stacks that are, individually, tied to any number of critical registers—one M-stack per critical register. The critical register can be a standard register, or a memory location that is used akin to a register. Any writes to the specific critical register are also written to the location pointed to by the M-stack's pointer. The interface between the critical register and the M-stack is isolated from other busses so that a transfer of data can take place between the M-stack and the critical register simultaneously and independently from other busses (either M-stack or common). Finally, the uniqueness of the M-stack requires the introduction of a new stack operation: “HOLD.” In a prior art stack, the stack pointer gets adjusted during both “read” and “write” operations. In contrast, the pointer for an M-stack is adjusted only during “read” and “hold” operations. During “write” operations to the M-stack, the M-stack pointer is not adjusted.

Other and further objects, features and advantages will be apparent from the following description of presently preferred embodiments of the invention, given for the purpose of disclosure and taken in conjunction with the accompanying drawings.

### BRIEF DESCRIPTION OF THE DRAWINGS

FIG. 1 is a schematic illustration of the register interface with the mirror stack of the present invention;

FIG. 2 is a schematic illustration of the logic interface of the mirror stack of the present invention; and

FIG. 3 is a timing diagram of the mirror stack of the present invention.

### DETAILED DESCRIPTION OF THE PREFERRED EMBODIMENTS

The present invention is a microprocessor architecture that supports a central processing unit that executes instructions and is responsive to interrupt requests. The architecture of the present invention enables the central processing unit to respond and to recover quickly from the servicing of such an interrupt.

In a first embodiment of the present invention, the time needed to service interrupt request for processors can be reduced significantly by adding stack structures to the processor that mirror the critical registers such as the Program Counter (PC), Status Register (SR), and other registers that are modified during the execution of typical software programs. Mirroring the registers eliminates the need to read the register values and then place them—one at a time—onto a typical stack structure. The mirrored stack memory structure is intended to be hidden from the user. The size and extent (i.e., the depth) of the mirror stack memory should be limited to those of the interrupt priority levels. Whenever an interrupt occurs when using a “mirrored” stack, the stack's pointer will be adjusted to the next free space on the stack in order to preserve the values of the registers. The register values (in addition to the Program Counter) will be updated during the execution of the return from interrupt instruction. The next step then, is to branch to the interrupt service routine.

Just implementing the “mirrored” stack for the registers will decrease significantly the time needed to service processor interrupts. However, in the preferred embodiment of the present invention, the interrupt control logic should be given a port to the Program Counter control logic in order to drive directly an interrupt vector address onto the Program Counter even before the completion of the execution of the current instruction.

Implementations of the two embodiments described above will minimize significantly any interrupt servicing latency during the CALL to, and RETURN from, the interrupt service routine. Any losses will be limited to the pipeline for pipelined processor architectures. At most, one CPU cycle during CALLs.

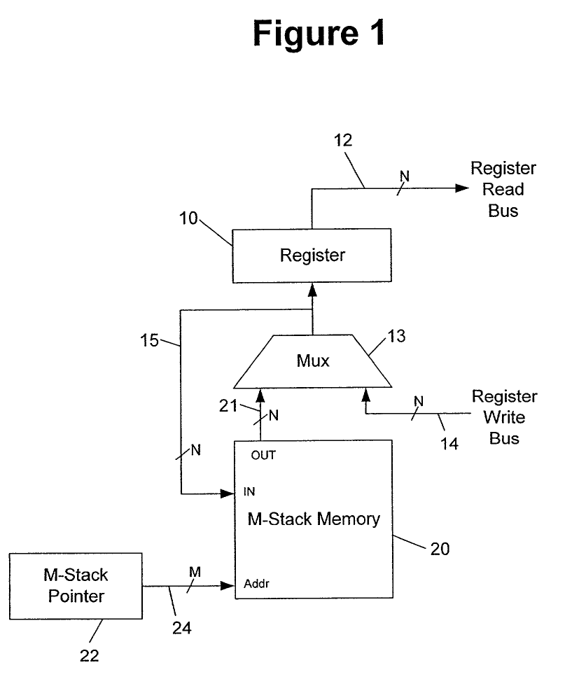

In order to realize the architecture described above, the difference between a conventional stack and a “mirrored stack” must be understood. A “mirroring” stack is a very specialized application of a stack. The mirroring stack is associated with a specific memory location or register for which the mirroring stack is intended to track (or mirror) its value. Because the mirror stack is always monitoring the value of the memory location/register, only the mirror stack's pointer needs to be adjusted when the value must be restored after or held before an interrupt event. FIG. 1 shows a block diagram of the mirror stack configuration that is tied to a specific register. As shown in FIG. 1, the (critical) register 10 is connected to both a read bus 12 and to a write bus 14. The mirror stack (M-stack) memory is also connected to the write bus 14 via a multiplexer (mux) 13. Like the register 10, the M-stack memory 20 can receive data from the write bus 14 via the mux 13 through signal line 15. In this sense, the M-stack memory 20 is associated with the register 10. The size of the read bus 12 and the write bus 14, designated by the letter “N” in FIG. 1, is equal to the size, in bits, of the register 10.

Referring again to FIG. 1, the M-stack pointer 22 is connected to the M-stack memory 20 via pointer bus 24. The mirror stack pointer 22 is adjusted during read and hold operations. During reads from the M-stack 20, one or more values are read from a previously pointed to location in the M-stack 20 (depending upon the number of mirroring stack structures in the system). The width of the pointer bus 24, designated by the letter “M” in FIG. 1, is calculated by the following formula:

M=┐log₂(Stack Depth)┌

The mirror stack has several characteristics that differentiate it from the stacks used in the prior art. First, the mirror stack is associated with a specific register or memory locations. Values to be read from the mirror stack go to a predetermined destination. Second, unlike conventional stacks, the mirror stack pointer is adjusted during hold and read operations and not during write operations. Finally, in the preferred embodiment of the present invention, the mirror stack and the specific register to which the mirror stack is associated should be isolated from any common bus in order to allow simultaneous updates within a single CPU cycle of the system that employs more than one mirror stack.

Mirror stacks can also be used to enable fast argument passing during subroutine calls. In that case, the user program will require access to the mirror stack in some manner in order to return the results of the call. However, this requirement is not required in all embodiments of the present invention. By the very nature of interrupts, it does not make sense to pass arguments to an interrupt service routine or to return results from an interrupt service routine when the state of the processor (during an interrupt) is typically not deterministic.

As mentioned before, simply using mirror stacks on each critical register will reduce significantly the time needed to service interrupts. Moreover, simply mirroring the registers would also ensure the value of the registers used during program execution. The present invention, however, goes even farther to reduce the latency associated with vectoring the program counter to the correct interrupt service routine. Having the Program Counter (PC) loaded with the correct interrupt vector address is the other half of the solution to reducing the latency time down to one or zero instruction cycles. Whether the latency is one cycle or zero cycles depends upon when in time during the current instruction's execution that the interrupt occurs.

For purposes of this disclosure, a critical register defined as any register or memory location for which the value in that register or memory location is desired to be returned to the state or value that it contained just before the invocation of an interrupt.

Generally, one of the recognized critical registers is the Program Counter (PC). In the preferred embodiment of the present invention, the PC is a critical register and has a mirror stack associated with it. Because the PC has a mirror stack (M-stack) that mirrors its value, the PC value is already on the M-stack and the PC is free to be loaded with an address where to fetch the next instruction. When mirroring the PC, attention should be directed to the issue of mirroring the next address from which the PC will load the next instruction. In the preferred embodiment of the present invention, the M-stack for the PC should mirror a value of PC+1 instruction word increment. Moreover, consideration should also be given to the execution of the current instruction, in which the next location may not be PC+1, but rather another program location.

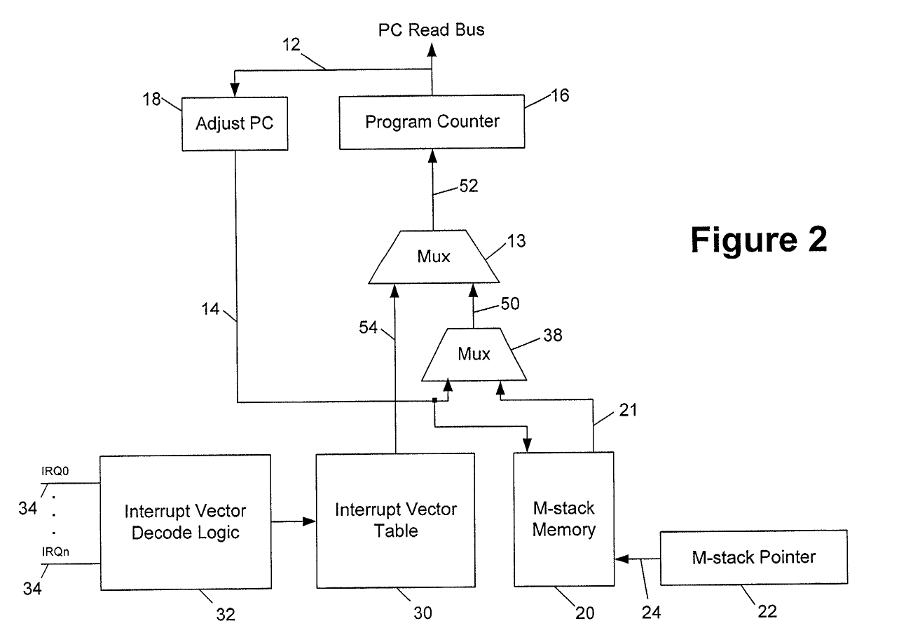

The interrupt control logic of the present invention must be modified somewhat from the logic of the prior art in order to enable the PC to be driven directly with the appropriate interrupt vector while sharing an interface to the PC with the M-stack that is associated with the PC. A block diagram for the M-stack associated with the PC and the interrupt control logic interfaces are illustrated in FIG. 2.

Referring now to FIG. 2, the critical register in this example is the program counter 16. As with the generic example shown in FIG. 1, the program counter 16 is connected to the register read bus 12. Unlike the generic case however, because the register in question is the program counter, the adjust program counter logic block 18 is also connected to the register read bus 12, to the multiplexer 38, and to the M-stack memory 20 via bus 14. The M-stack memory 20 is connected to both inputs to the multiplexer 38 (via bus 14 and 21) as shown in FIG. 2. As with the generic case illustrated in FIG. 1, the M-stack pointer 22 is connected to the M-stack memory 20 via pointer bus 24. The M-stack pointer 22, however, can be used for more than one (unique) M-stack memories. The interrupt control logic interface is completed with the addition of the interrupt vector decode logic 32 and the interrupt vector table 30, the latter of which is connected to the mux 13 via bus 54. The interrupt vector decode logic 32 takes n-number of inputs 34 (IRQ0 to IRQn) and, after decoding the IRQ input, outputs its result to the interrupt vector table 30 which, if necessary, makes the appropriate write input to the multiplexer 13 as illustrated in FIG. 2.

One feature of the present invention that enhances the ability to handle interrupts quickly is that the architecture of the present invention supports multiple levels of interrupt priorities. When applying the mirror stacks (M-stacks) to support interrupts, the levels of interrupt priorities will be used to define the needed depth of the mirror stack(s). For processors with a large number of working registers, adding a mirror stack for each register would be costly. In that case, the mirror stacks should be tied to a few of the registers (i.e., only a few of the registers are defined as “critical”). Those few registers are typically the ones that are to be modifiable by an Interrupt Service Routine (ISR).

Other considerations of the PC affect the preferred embodiment of the present invention. Specifically, during the execution of a BRANCH or GOTO instruction, the value that the M-stack associated with the PC should be mirrored to is the GOTO address as unmodified instead of the PC +increment. The M-stack for the PC input interfacing logic must, therefore, be able to take the execution of such instructions into consideration.

The mirror stack of the present invention is distinguished from the prior art in other features and operations. For instance, in a conventional prior art stack, the stack pointer is adjusted during reads and writes. However, a mirror stack pointer of the present invention is adjusted during holds and reads from the mirror stack, but is never modified during writes to the mirror stack because the mirror stack may be written to multiple times without the need to adjust the mirror stack pointer. Unlike the prior art stacks, the mirror stack of the present invention is tied to a specific register, typically a critical register such as the Program Counter. Moreover, the mirror stack introduces a new type of stack operation called “HOLD” that is not found in traditional stacks.

In an alternate embodiment of the present invention, the latency associated with servicing the interrupts can be fixed. When such a characteristic is desired, the interrupt line will be monitored only during the start of the instruction fetch phase. By doing so, the latency associated with the servicing of the interrupts will be a fixed one-instruction delay.

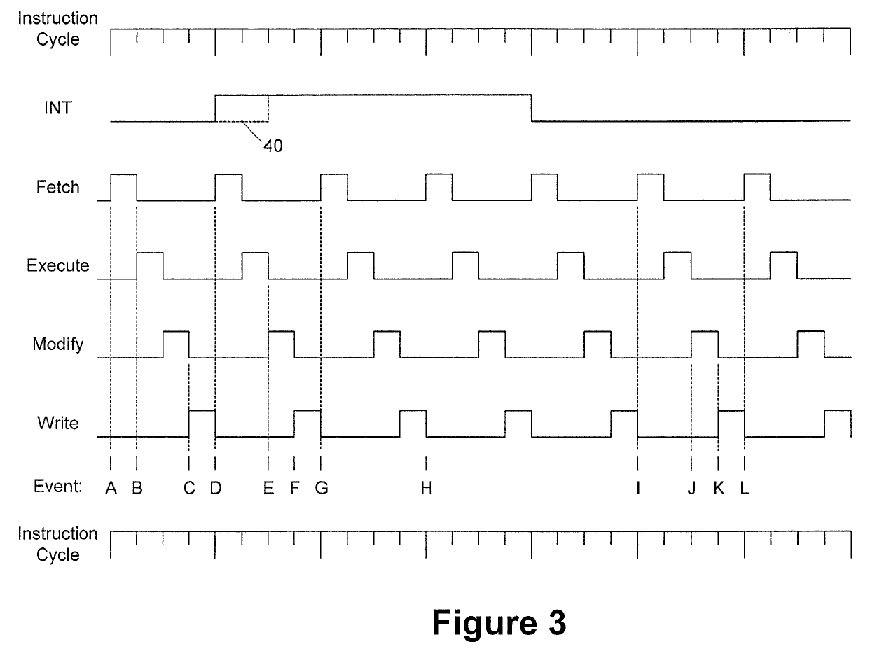

Attention is directed to the timing diagram of FIG. 3. Specifically, the timing diagram is bracketed by two instruction cycle rulers that indicate the beginning of each instruction cycle (the long marks) and intermediate portions (the short marks). The first timing element is the interrupt (INT) line, followed by the Fetch, Execute, Modify, and Write lines, respectively. In FIG. 3, an instruction normally has four phases (fetch, (decode) execute, modify, and write) that are started and completed within one instruction cycle. To illustrate the fast servicing of processor interrupts, the timing diagram of FIG. 3 has a series of events “A” through “L.” Table 1 describes each event at the time interval shown in FIG. 3 and covers three different types of instruction execution events. The three types of instruction events are: 1) instruction execution without interrupts (“A” through “D”); 2) instruction execution with an interrupt (“D” through “H”); and 3) instruction execution upon returning from the interrupt (“I” through “L”). The interrupt “window of opportunity” is designated by the dashed box 40 in FIG. 3. It is within the window 40 that an interrupt can be recognized, with the servicing of the interrupt able to begin in the next instruction cycle. The method of the present invention can be ascertained by stepping through the example of FIG. 3 with reference to the events outlined in Table 1. It should be noted that the example as outlined in Table 1 assumes that the servicing of the interrupt can be handled in one instruction cycle. If the handling of the interrupt requires more than one instruction cycle, there will be a corresponding delay in the resumption of normal execution. This is the case when instructions are pre-fetched.

TABLE 1

| Event | Description |
|---|---|
| A | The Program Counter (PC) is placed on the address bus and the instruction to be |
| | executed is fetched from memory. |
| B | The instruction that is fetched from memory is captured in the Instruction Register (IR) |
| | where it is decoded and any read that is needed as part of the instruction's operation is |
| | carried out. It is at this point that the PC is incremented by one to point to the next |
| | instruction. At the same time, the mirror stack (M-stack) for the PC also captures this |
| | “next” address (i.e., PC + 1) because the current instruction that is being executed could |
| | be a GOTO or some other type of branch or skip instruction. In the case of a branch or |
| | skip instruction, the true “next” address will not be known until the end of the current |
| | instruction's execution. |
| C | At this point, the results of the instruction's execution are known and the results are |
| | stored in memory or an appropriate register. According to the present invention, if the |
| | destination is a register, the result will also be written to that register's corresponding |
| | mirror stack (M-stack). |
| D | This point defines the start of a window of opportunity (element 40 of FIG. 3) in |
| | which an interrupt can be recognized. This point is also the start of the next instruction |
| | cycle also called the “current instruction.” |
| E | This is the critical point during the execution of an instruction in which the decision |
| | will be made to service the interrupt(s) on the next instruction cycle or not (if zero |
| | latency is allowed). This point also defines the end of the window of opportunity in |
| | which interrupts will be recognized. If the interrupt occurs after this point, the interrupt |
| | will experience the worst case latency of one instruction cycle (i.e., the interrupt will |
| | not start to be serviced until Event “H”). From that perspective, this point defines the |
| | start of a window of opportunity in which an interrupt may occur where the service |
| | latency will be one instruction cycle. For this example, it is assumed that the interrupt |
| | occurred between points “D” and “E” so that the interrupt will be serviced in the next |
| | instruction cycle. An interrupt at this point will enable the PC to be driven with a value |
| | from an interrupt vector table that contains the address of the first instruction for the |
| | interrupt service routine. In this example, it will be assumed that the interrupt was |
| | received between points “D” and “E” and thus the interrupt will be serviced starting at |
| | the next instruction cycle (Event G). |
| F | This is the point where the value driving the inputs to the PC is captured. As with point |
| | “C” above, the result of the current instruction is written. If the results of the current |
| | instruction are to be written to a critical register, the result would also be written to the |
| | mirror stack corresponding to that critical register - with one exception. Had the |
| | current instruction been a branching instruction, the result would be written to the PC's |
| | mirror stack and not to the PC itself because the PC will be loaded from the interrupt |
| | vector table instead. |
| G | This point marks the end of the previous instruction that was executed before servicing |
| | the interrupt. It is also the point where all of the mirror stack pointers get adjusted in |
| | order to hold the pre-interrupt values of the critical registers. This is also the point |
| | where an interrupt would have been serviced if the interrupt had occurred between |
| | points “D” and “E.” |
| H | This is the point where an interrupt would have been serviced if the interrupt had |
| | occurred between points “E” and “G.” |
| I | This point denotes the start of the RETURN_FROM_INTERRUPT instruction |
| | execution. From this point on, the fetch and execute phases are carried out in a |
| | normal fashion. |
| J | Here, the various M-stack pointers are adjusted to point to the pre-interrupt register |
| | value with that value simultaneously being driven at the corresponding register inputs. |
| | In an alternative embodiment of the present invention, the M-stack pointer is adjusted |
| | at the beginning of the execute phase and the read is carried out at this point. |
| K | At this point, all of the registers are updated to their pre-interrupt values and the PC |
| | is updated with the “next” instruction address from its respective M-stack. |
| L | This is the end point of the interrupt service routine and the starting point of the next |
| | instruction that was to be executed when the processor was interrupted. |

In some processor architectures, such as the PIC™ microcontrollers manufactured by Microchip Technology, Inc. of Chandler, Ariz., pre-charge type memory structures are used and this affects the timing events stated above in Table 1. For processors that do not use pre-charge type memory structures, the embodiments mentioned above are valid. Assuming the pre-charge requirements can be met, then the embodiments disclosed herein are also valid for PIC architectures.

In summary, the present invention provides one or more M-stacks that are, individually, tied to any number of critical registers—one M-stack per critical register. The critical register can be a standard register, or a memory location that is used akin to a register. Any writes to the specific critical register are also written to the M-stack's currently pointed to location. The interface between the critical register and the M-stack must be isolated from other busses so that a transfer can take place between the M-stack and the critical register simultaneously and independently from other busses or other M-stacks. Finally, the uniqueness of the M-stack requires the introduction of a new stack operation: “HOLD.” In a prior art stack, the stack pointer gets adjusted during both “read” and “write” operations. In contrast, the pointer for an M-stack is adjusted only during “read” and “hold” operations. During “write” operations to the M-stack, and during a write access to the critical register, the M-stack pointer is not adjusted.

The present invention, therefore, is well adapted to carry out the objects and attain both the ends and the advantages mentioned, as well as other benefits inherent therein. While the present invention has been depicted, described, and is defined by reference to particular preferred embodiments of the invention, such references do not imply a limitation on the invention, and no such limitation is to be inferred. The invention is capable of considerable modification, alternation, alteration, and equivalents in form and/or function, as will occur to those of ordinary skill in the pertinent arts. The depicted and described preferred embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A microprocessor architecture comprising:
a central processing unit, said central processing unit is constructed and arranged to execute instructions, said central processing unit further capable of responding to an interrupt request;
a register read bus;
a multiplexer;
a register write bus connected to said multiplexer;
at least one register, said register connected to said register read bus and to said multiplexer, said register constructed and arranged to deposit data onto said register read bus and to accept data from said multiplexer;
a mirror stack memory, said mirror stack memory connected to said multiplexer, said mirror stack memory constructed and arranged to receive data from said multiplexer and to deposit data onto said multiplexer, said mirror memory stack is associated with said register; and
a mirror stack pointer, said mirror stack pointer is connected to said mirror stack memory, said stack pointer being adjusted during read operations;
wherein, during reads from said memory stack, one or more values are read from a previously pointed to location in said memory stack.

2. A microprocessor architecture as in claim 1, wherein said architecture further comprising an interrupt control logic, said interrupt control logic having a port to a program counter control logic in order to directly drive an interrupt vector address into a program counter before the completion of the execution of a current instruction.

3. A microprocessor architecture as in claim 1, wherein said register write bus is isolated from a common bus in order to enable simultaneous updates in a single system that employs multiple mirror stack memories.

4. A method of handling an interrupt of a central processing unit, said method comprising the steps of:
(a) providing a central processing unit responsive to interrupts;
(b) placing the contents of an program counter register onto an address bus, said contents of said program counter register being an address to a first instruction, said program counter register having a program counter M-stack associated with said program counter register;
(c) fetching said first instruction from a memory;
(d) capturing said first instruction in an instruction register;
(e) decoding said first instruction, if said decoded first instruction requires a read that is needed as part of said first instruction's operation, then performing a read;
(f) during said step (e), adjusting said program counter register in order to point to a next instruction;
(g) capturing an address for said next instruction from said program counter register;
(h) if a first result from the execution of said first instruction is to be stored in said memory, then storing said first result in said memory, otherwise, if said first result from the execution of said first instruction is to be stored in a critical register, then storing said first result in said critical register and writing said first result to an M-stack associated with said critical register;
(i) determining if an interrupt, if received, will be serviced and executing a current instruction, said current instruction being an instruction predefined to be executed after said execution of said first instruction;
(j) if said interrupt is to be serviced, then enabling said program counter register to be driven with a value from an interrupt vector table that contains an address of a first interrupt service routine instruction;
(k) capturing said address of said first interrupt service routine instruction with said program counter M-stack and writing a current result from the execution of said current instruction, if said current result are to be written to a critical register, then said current result shall also be written to a mirror stack corresponding to said critical register except on the condition that if said current instruction is a branching instruction, then said current result shall be written to said program counter M-stack;
(l) executing said first interrupt service routine instruction and adjusting at least one M-stack pointer in order to store the at least one pre-interrupt register values of said critical registers;
(m) returning from said interrupt service routine; and
(n) adjusting said at least one M-stack pointer to point to said at least one pre-interrupt register values, said at least one pre-interrupt register values being simultaneously driven at a corresponding register input;
wherein after said step (n) said interrupt service routine will have ended and a starting point of the next instruction to be executed before said interrupt may be executed.

5. A method of handling an interrupt of a central processing unit as in claim 4, wherein said adjusting step (n) occurs during an execute phase.
